(19) United States
(12) Patent Application Publication
(10) Pub. No.: US 2009/0319850 A1
(43) Pub. Date: Dec. 24, 2009

(54) LOCAL DROP CONTROL FOR A TRANSMIT BUFFER IN A REPEAT TRANSMISSION PROTOCOL DEVICE

(75) Inventors: Seung Baek, Seoul (KR); Ramanuja Vedantham, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/490,587

(22) Filed: Jun. 24, 2009

Related U.S. Application Data
(60) Provisional application No. 61/075,154, filed on Jun. 24, 2008.

(51) Int. Cl. H04L 1/08; G06F 11/14

(52) U.S. Cl. 714/748; 714/E11.131

(57) ABSTRACT

A wireless communication device includes a transmit buffer and control logic coupled to the transmit buffer. The control logic selectively implements an “ACK2 scheme” that drops a data block in the transmit buffer based on reception of two consecutive HARQ ACKs associated with the data block.

### CROSS-REFERENCE TO RELATED APPLICATIONS

The present application claims priority to U.S. provisional patent application Ser. No. 61/075,154, filed Jun. 24, 2008, and entitled “Statistical Method for Buffer Management Using Consecutive HARQ Feedbacks in LTE” hereby incorporated herein by reference.

### BACKGROUND

With the proliferation of modern wireless technologies, networked devices have become nearly ubiquitous. Networked devices often employ a multi-layered protocol architecture to simplify communications. The layers serve to isolate each function to a particular hierarchical system, thereby isolating other systems within the protocol hierarchy from the details of functionalities implemented in disparate layers.

Network protocol layering is often based on the Open Systems Interconnection Model (“OSI”), as specified in ITU-T Recommendation X.200. The OSI model specifies seven protocol layers traversed by data as it passes between the transmission media and the relevant application. Each layer may copy the data received from the previous layer, and pass a modified version of the data to the subsequent layer for further processing.

The first and lowest layer of a protocol stack is often termed the “physical” layer. The physical layer provides the network device with means to access the physical media interconnecting devices, and to transmit and receive bit streams via that media.

The data link layer resides atop, and is serviced by, the physical layer of the network stack. The data link layer may provide a variety of services to higher levels, and therefore comprise a number of functionalities. Representative data link layer functionalities include error correction by automatic retransmission request, ciphering and deciphering of data units, and segmentation and reassembly of data units. The data link layer may be further sub-divided into a number of sub-layers to implement the required functionalities. Each sub-layer receives data from the previous sub-layer, processes the data, and passes the processed data to the next sub-layer for further processing. Sub-layer processing may include copying, as well as other manipulations of the data.

Many wireless networking protocols include MAC-level automatic repeat request (ARQ) protocols to control re-transmissions in the presence of channel errors. For the 3GPP EUTRA (LTE) standard, Hybrid-ARQ (HARQ) and Window-based ARQ are used. HARQ attempts to recover channel errors by combining transmitted or retransmitted transports blocks (TBs) at the FEC (forward error correction) level. The HARQ protocol signaling is managed by the media access control (MAC) layer whereas the PHY layer performs the actual combining of TBs. Window-based ARQ is used in AM (Acknowledged Mode) operation of the RLC (Radio Link Control) Layer and improves efficiency by using a single feedback message (referred to as RLC status report) to acknowledge multiple transmitted packets. In LTE, due to the limitation of the sequence number space assigned to RLC PDUs, the window size is set to 512 or 16 depending on the sequence number space associated with the particular flow.

The MAC layer multiplexes all the RLC packets (RLC PDUs) belonging to one or more flows into a single TB for transmission over the air interface. The ARQ protocol (AM mode) operates on top of HARQ retransmissions which are performed at the transport block level. An uplink traffic example (traffic transmitted by user equipment (UE) to a base station (eNB)) is provided herein. However, the same issues apply to downlink traffic as well.

In AM mode uplink transmissions, the RLC PDUs at the UE need to be buffered at the RLC sub-layer until an RLC status report (generated by eNB) is received. Once the RLC status report is received, the RLC PDUs can be released from memory. The generation of the RLC status report at the eNB is triggered by detection of packet loss or detection of a RLC status report “poll” request from the UE. The time between polls is referred to as the polling period and is negotiated between the UE and the eNB. However, unnecessary triggering of an RLC status report is undesirable when HARQ retransmissions are still ongoing. Thus, the polling period should be sufficiently large so as to avoid unnecessary polling. In some cases, the polling period is based on packet loss detection.

Since ARQ is running on top of HARQ, the packet error rate (PER) seen by the RLC layer before applying ARQ in AM mode is approximately 8e-3. In LTE, the uplink HARQ is characterized as a synchronous SAW (stop-and-wait) ARQ with 8 processes. The maximum number of retries is configurable per UE basis (as opposed to per Radio Bearer basis). For LTE, the recommended reliability of one TB transmission is 3e-1. Considering the HARQ target reliability of 8e-3, the maximum number of retires is usually set at the minimum of 3. The transmissions and retransmissions of a MAC PDU up to the maximum number of retries is referred to as a HARQ round. In response to uplink data transmissions, HARQ feedback is signaled by ACK/NACK via PHICH (a downlink physical control channel for HARQ feedback). Each ACK/NACK is sent at the n+4^{th} frame in response to a TB sent at the N^{th} frame.

Due to the timing of synchronous HARQ, there is delay associated with packet loss detection. For example, if a TB is sent on HARQ process number 1 and is lost, the eNB detects the missing TB at the HARQ layer, but will not generate an RLC status report unless the UE exhausts the maximum number of retries. Thus, the eNB will keep receiving successfully decoded TBs on different HARQ processes than process number 1 and will start a timer (referred to a HARQ reordering timer) corresponding to all the RLC PDUs embedded in the TB corresponding to process number 1. The HARQ reordering timer will expire after the estimated time for three retransmissions and will declare the TB (with all embedded RLC PDUs) as lost if the TB is not received before the timer expires. Since the subframe is 1 ms in duration, the transmission for a given HARQ process occurs at every 8 ms. Accordingly, the HARQ reordering timer is set to at least 24 ms and the RLC status report of a missing PDU is generated only after the expiry of the HARQ reordering timer for that flow.

The polling period should be longer than or equal to the HARQ reordering timer period since that is the minimum length of time after which the eNB can detect packet loss after HARQ. In any case, the UE needs to buffer all the packets until the reception of the RLC status report, which is not generated more often than the HARQ reordering timer (at least 24 ms). Due to the buffering associated with the relatively infrequent generation of the RLC status report (at least 24 times the subframe period), the memory requirement in the transmitter side (UE side for this example) increases as the requirement for higher data rates in uplink flows increases.

### SUMMARY

In at least some embodiments, a wireless communication device comprises a transmit buffer and control logic coupled to the transmit buffer. The control logic selectively implements an “ACK2 scheme” that drops a data block in the transmit buffer based on reception of two consecutive HARQ ACKs associated with the data block.

In at least some embodiments, a transmitter comprises a Radio Link Control (RLC) layer with an RLC buffer. The RLC layer causes a data block in the RLC buffer to be dropped in response to a local RLC status report. The transmitter also comprises a Media Access Control (MAC) layer coupled to the RLC layer. The MAC layer generates the local RLC status report upon receipt of a HARQ ACK corresponding to the data block and a supplemental validity indicator for the data block.

In at least some embodiments, a method for a Long Term Evolution (LTE) device comprises storing a data block in a transmit buffer. The method also comprises dropping the data block from the transmit buffer before receipt of a remotely-generated status report related to the data block based on a locally-generated status report related to the data block.

### BRIEF DESCRIPTION OF THE DRAWINGS

For a detailed description of exemplary embodiments of the invention, reference will now be made to the accompanying drawings in which:

FIG. 1 shows a wireless network in accordance an embodiment of the disclosure;

FIG. 2 shows a protocol stack and sub-layers of the data link layer of the protocol stack in accordance with an embodiment of the disclosure;

FIG. 3 shows a communication system in accordance with an embodiment of the disclosure;

FIG. 4 shows another communication system in accordance with an embodiment of the disclosure;

FIG. 5 shows a timing diagram for an ACK2 scheme in accordance with an embodiment of the disclosure;

FIG. 6 shows a timing diagram for an ACK/NDI scheme in accordance with an embodiment of the disclosure; and

FIG. 7 shows a method in accordance with an embodiment of the disclosure.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices, or a sub-system thereof.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment. While embodiments of the present disclosure are described primarily in the context of wireless communication systems, those skilled in the art will recognize that embodiments are applicable to data link layer protocols in a variety of communication and networking systems employing wire, optical and other transmission media. The present disclosure encompasses all such embodiments.

Embodiments of the disclosure are directed to wireless communication devices that implement repeat transmission protocols such as automatic repeat request (ARQ) protocols. In at least some embodiments, a wireless communication device comprises a transmit buffer and control logic coupled to the transmit buffer. The control logic selectively drops a data block in the transmit buffer based on an “ACK2 scheme” and/or an “ACK/NDI scheme”. As used herein an ACK2 scheme refers to dropping a data block from a transmit buffer if two consecutive HARQ ACKs related to the data block are received by the transmitting device. As used herein, an ACK/NDI scheme refers to dropping a data block from a transmit buffer if a HARQ ACK related to the data block and a new data indicator (NDI) are received by the transmitting device. In at least some embodiments, the ACK2 scheme and/or the ACK/NDI scheme cause generation of a local status report (i.e., a status report generated within the wireless communication device) related to the data block. In such case, the data block is dropped from the transmit buffer upon receipt of the local status report indicating the data block can be dropped. In accordance with at least some embodiments, the transmit buffer is sized based on an estimation of how the ACK2 scheme and/or the ACK/NDI scheme affect buffering needs. Estimates indicate that implementation of the ACK2 scheme can reduce transmit buffer size by approximately 50% compared to waiting for a remote status report (i.e., a status report periodically generated by a device that receives transmissions from the wireless communication device) to determine when to drop data blocks from the transmit buffer. Further, implementing a combination of the ACK2 scheme and the ACK/NDI scheme reduces buffer size by even more than 50% compared to waiting for a remote status report. In accordance with LTE embodiments, the transmit buffer is part of a Radio Link Control (RLC) layer (e.g., the transmit buffer is an RLC buffer) and the control logic (e.g., the ACK2 scheme, the ACK/NDI scheme, and local status report generation) is part of a Media Access Control (MAC) layer. The disclosed transmit buffer and control logic may be implemented for downlink and uplink scenarios (i.e., the transmitter-receiver can be either base station (BS)-user equipment (UE) or UE-BS).

In at least some embodiments, a sequence of HARQ ACK/NACK information is considered so as to statistically reduce the buffer requirement at the RLC sub-layer in AM mode. The HARQ ACK/NACK provides information on the status of outstanding packets to the RLC layer. However, the received ACK/NACK is subject to error (i.e., an ACK may be received as a NACK and vice versa). The error probability of receiving a NACK as an ACK (the NACK-to-ACK error rate) is 1e-4. Meanwhile, the error probability of receiving an ACK as a NACK (the ACK-to-NACK error rate) is 1e-2. Due to this error, receiving a single ACK on the UE side is not a reliable indicator of successful data delivery since the packet drop probability of each RLC PDU is on the order of 1e-6 to 1e-9 (assuming compliance with the specification and 2-3 transmission attempts).

Without undermining the reliability of the RLC AM mode, embodiments employ the ACK2 scheme when a given HARQ ACK is in response to a TB that is not the last retransmission of a HARQ round. In other words, the reliability of receiving a HARQ ACK two consecutive times during the same HARQ process is comparable to the packet drop probability during the RLC AM mode.

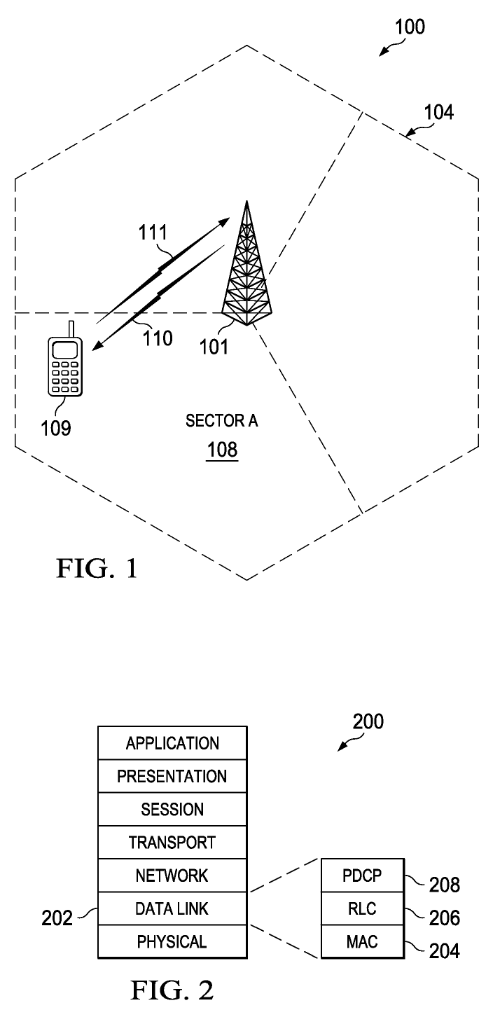

FIG. 1 shows a wireless network 100 in accordance an embodiment of the disclosure. As shown, the wireless network 100 includes base station 101, though in practice, a wireless telecommunications network may include more base stations than illustrated. A base station may also be known as a fixed access point, a Node B, an e-Node B, etc. Base station 101 is operable over cell 104. The cell 104 is further divided into sectors. In the illustrated network, the cell 104 is divided into three sectors. Cellular telephone or other user equipment (“UE”) 109 is shown in sector A 108, which is within cell 104. Though as a matter of simplicity only a single UE is shown, in practice system 100 may include any number of UEs. The UE 109 may also be called a mobile terminal, a mobile station, etc. Base station 101 transmits to UE 109 via down-link 110, and receives transmissions from UE 109 via up-link 111.

Message transfer between base station 101 and UE 109 is facilitated by multi-layer protocol stacks. Generally, each layer and/or sub-layer of a transmitter protocol stack adds a header to the data unit being passed to the next lower layer or sub-layer. The headers include fields identifying the operations performed at that protocol layer. Each layer or sub-layer of a receiver protocol stack parses the header inserted in the corresponding transmission layer to allow reconstruction of a data unit provided to the next higher layer or sub-layer. As disclosed herein, either or both the base station 101 and the UE 109 implement a transmit buffer and a control algorithm for dropping data blocks from the transmit buffer. For example, the control algorithm may be based on the ACK2 scheme and/or the ACK/NDI scheme. Also, the control algorithm may involve local generation of status reports instead of waiting for receipt of remotely generated status reports. In LTE embodiments, the transmit buffer may be part of an RLC sub-layer of a data link layer and the control algorithm may be part of a MAC layer of a data link layer. Implementation of the control algorithm enables the transmit buffer size to be reduced compared to waiting for remotely generated status reports.

FIG. 2 shows an illustrative seven layer protocol stack 200. The various layers of the stack may be further divided in sub-layers. As illustrated, the data link layer 202 of the exemplary protocol stack may be further sub-divided into multiple sub-layers as prescribed by, for example, the Long Term Evolution (“LTE”) wireless telecommunication standard of the Third Generation Partnership Project (“3GPP”). In FIG. 2, the data link layer 202 comprises a Media Access Control (“MAC”) sub-layer 204, a Radio Link Control (“RLC”) sub-layer 206, and a Packet Data Convergence Protocol (“PDCP”) sub-layer 208. Note that the data link layer 202 may comprise various other sub-layers not illustrated here.

Servicing the protocol stack layers, for example, the data link layer 202 requires a substantial amount of data packet manipulation and intensive bit level data processing. The above-mentioned sub-layers of the data link layer may, for example, add/remove headers, encrypt/decrypt payloads, segment/reassemble data blocks, concatenate data units, pad data units, compress/decompress headers, etc. The performance of these operations may be communicated through headers constructed at the various sub-layers of the data link layer 202. In accordance with some embodiments, the discussed operations may be used to implement ARQ or HARQ protocols. As an example, using these operations, a base station may provide ACKs related to data blocks transmitted by a UE. Additionally, the base station may provide NDIs to a UE. In response to consecutive ACKs related to a given data block or in response to an ACK related to the given data block together with an NDI, the UE drops that given data block from UE's transmit buffer.

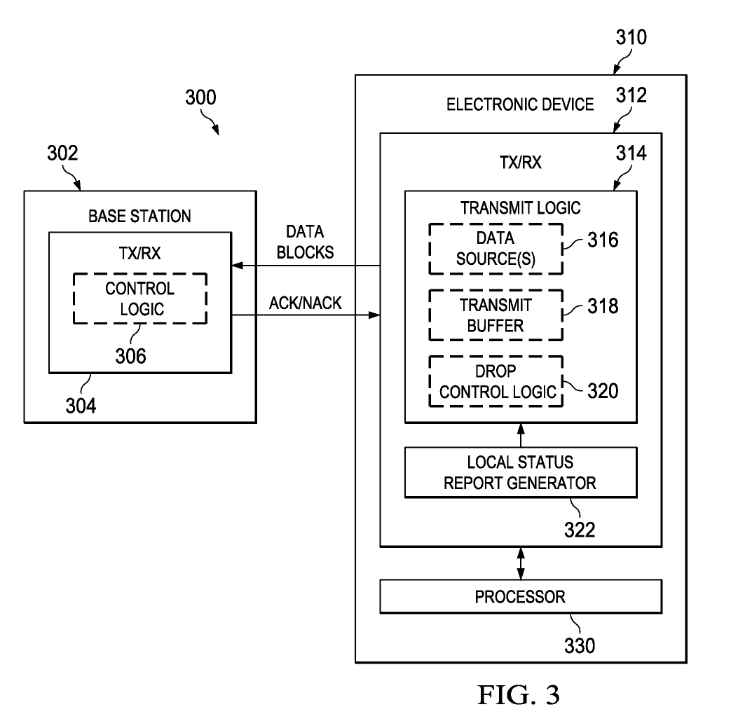

FIG. 3 shows a communication system 300 in accordance with an embodiment of the disclosure. As shown, the communication system 300 comprises a base station 302 in communication with an electronic device 310. The base station 302 comprises a transceiver (TX/RX) 304 having control logic 306. In operation, the control logic 306 enables the transceiver 304 to process data blocks received from the electronic device 310 and to transmit acknowledgements (ACKs/NACKs) to the electronic device 310 in accordance with the LTE protocol or another protocol that employs Hybrid Automatic Repeat Request (HARQ) technology.

As shown, the electronic device 310 comprises a processor 330 coupled to a transceiver 312. In operation, the electronic device 310 performs various functions by providing instructions/data to the processor 330 for execution. In part, these instructions/data may be stored in a memory (not shown) accessible to the processor 330. Additionally or alternatively, instructions/data may be transmitted to the electronic device 310 and received by the transceiver 312 for subsequent execution by the processor 330 or for use with an application being executed by the processor 330.

As shown, the transceiver 312 comprises transmit logic 314. In accordance with at least some embodiments, the transmit logic 314 prepares data blocks (e.g., a transport block with multiple code words) for transmission from at least one of a plurality of data sources 316. Each data block to be transmitted is stored in the transmit buffer 318 and, if needed, can be retransmitted by retrieving the data block from the transmit buffer 318 rather than from the data sources 316. As shown, the transmit logic 314 also comprises drop control logic 320 in communication with the transmit buffer 318. The drop control logic 320 directs the transmit buffer 318 to drop a data block when consecutive HARQ ACKs related to the data block are received. Alternatively, the drop control logic 320 directs the transmit buffer 318 to drop a data block when a HARQ ACK related to the data block is received together with an NDI. In at least some embodiments, the drop control logic 320 control the content of the transmit buffer 318 based on a local status report provided by a local status report generator 322 coupled to the transmit logic 314. The local status report generator 322 may generate a local status report when consecutive HARQ ACKs related to a data block are received. Alternatively, the local status report generator 322 may generate a local status report when a HARQ ACK related to a data block is received together with an NDI.

In summary, the electronic device 310 represents a wireless communication device having a transmit buffer 318 and control logic (the drop control logic 320) coupled to the transmit buffer 318. The transmit buffer 318 may be part of the RLC layer of the electronic device 310 and the control logic may be part of the MAC layer of the electronic device 310. The control logic selectively implements an ACK2 scheme that drops a data block in the transmit buffer 318 based on reception of two consecutive HARQ ACKs associated with the data block. In such case, the transmit buffer 318 is sized based on the ACK2 scheme. For example, the transmit buffer may be sized based on the buffer reduction formula: [T_{NACK2}−(α*T_{ACK2}+β*T_{NACK2})]/T_{NACK2}, where T_{NACK2}=status report timing without the ACK2 scheme, T_{ACK2}=status report timing with the ACK2 scheme, α=a percentage estimate of how often the ACK2 scheme is used, and β=1−α. The control logic may selectively implement an ACK/NDI scheme that drops a data block in the transmit buffer based on reception of a HARQ ACK associated with the data block and reception of a new data indicator (NDI). In such case, the transmit buffer 318 is sized based on the ACK/NDI scheme. In some embodiments, the control logic implements both the ACK2 scheme and the ACK/NDI scheme and thus the transmit buffer 318 is sized based on the ACK2 scheme and the ACK/NDI scheme. In some embodiments, the control logic operates only during Acknowledged Mode (AM) operation of the wireless communication device.

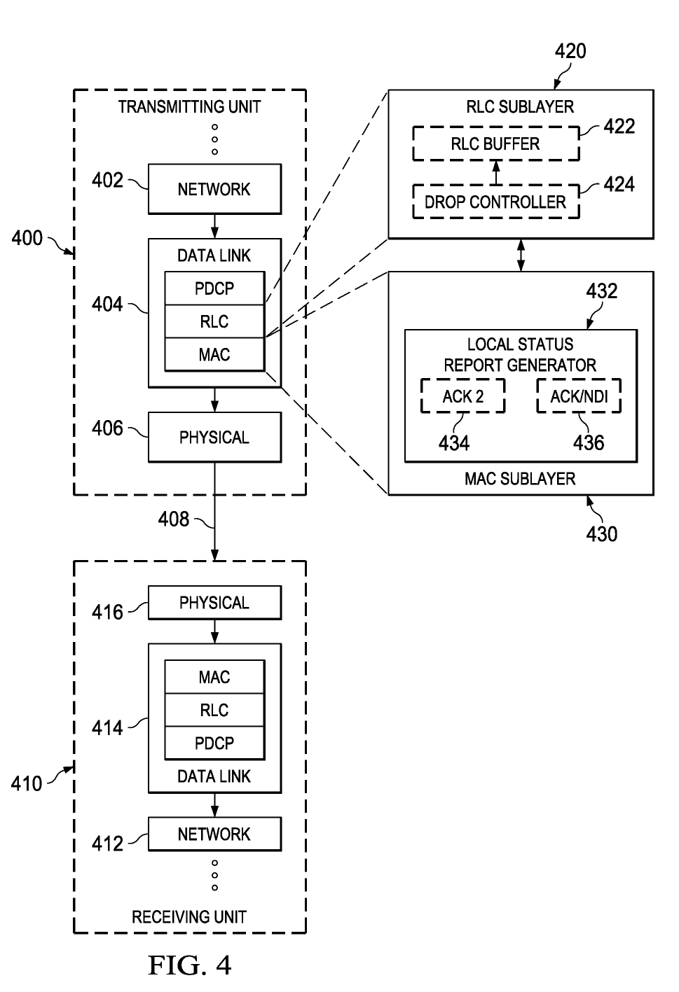

FIG. 4 shows another communication system 400 in accordance with an embodiment of the disclosure. More specifically, FIG. 4 shows wireless devices including protocol stacks in accordance with embodiments of the invention. A message originates in the network layer 402 (layer 3), or possibly a layer above the network layer 402 of transmitting unit 400. The message is passed down to layer 2, the data link layer 404, for processing in the various sub-layers. For example, PCDP sub-layer processing may comprise internet protocol (“IP”) header compression and/or data encryption and/or addition of PDCP headers. RLC sub-layer processing may comprise segmentation, the decomposition of the PCDP data unit into multiple RLC data units when the PDCP data unit is larger than the RLC data unit, and the addition of RLC headers. MAC sub-layer processing may comprise assembling multiple RLC data units into a larger MAC data unit, prefixing a header to the data unit, and encrypting the data. MAC sub-layer data units are delivered to the physical layer 406 for transmission via media 408 to the receiving unit 410.

The protocol stack of receiving unit 410 reverses the processing applied in the protocol stack of transmitting unit 400 to reconstruct the message passed from network layer 402 to the data link layer of transmitting unit 400. Reversal of the processing applied in the transmitting unit 400 protocol stack is enabled by the headers prefixed to the data unit at each layer/sub-layer. Error correction techniques may also be applied in the sub-layers of the data link layer 414 to ensure error free delivery of data units. In addition, the receiving unit 410 is able to transmit HARQ ACKs, NDIs, and status reports to the transmitting unit 400.

In response to receiving HARQ ACKs, NDIs, and/or status reports, the transmitting unit 400 dynamically determines whether to buffer new data blocks, to drop buffered data blocks, or to retransmit buffered data blocks. As shown in the embodiment of FIG. 4, the transmitting unit 400 comprises an RLC sub-layer 420 having an RLC buffer 422 coupled to a drop controller 424, which controls when data blocks are dropped from the RLC buffer 422. In at least some embodiments, the drop controller 424 operates based on the ACK2 scheme and/or the ACK/NDI scheme. As an example, the MAC sub-layer 430 of FIG. 4 is shown to have a local status report generator 432, which may generate a local status report based on the ACK2 scheme 434 and/or the ACK/NDI scheme 436. The local status report is provided to the drop controller 424, which causes a given data block in the RLC buffer 422 to be dropped based on the information in the local status report.

In summary, the RLC layer 420 may cause a data block in the RLC buffer 422 to be dropped in response to a local RLC status report that is generated upon receipt of a HARQ ACK corresponding to the data block and a supplemental validity indicator for the data block. The supplemental validity indicator may be a subsequent HARQ ACK related to the data block. Alternatively, the supplemental validity identifier may be a new data indicator (NDI). In accordance with embodiments, the RLC buffer 422 is sized based on an estimation of how often local RLC status reports will be generated.

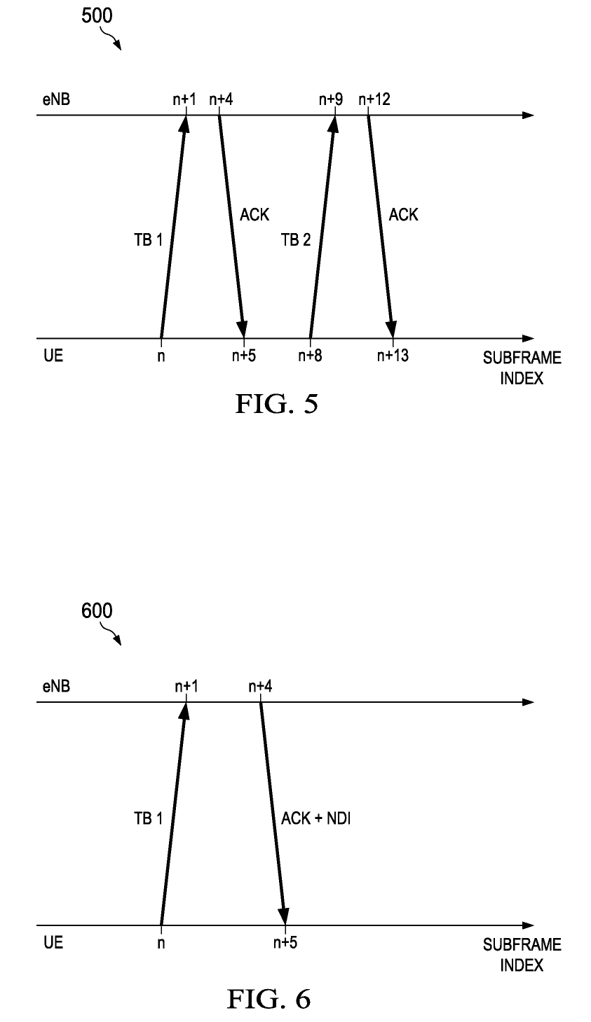

FIG. 5 shows a timing diagram 500 for an ACK2 scheme in accordance with an embodiment of the disclosure. More specifically, the timing diagram 500 shows a subframe index for communications between a UE and an eNB. At time “n”, a UE transmits a transport block (TB1) to an eNB. At time “n+1”, the eNB receives TB1. At time “n+4”, the eNB transmits an ACK to the UE as confirmation that TB1 was successfully received. At time “n+5”, the UE receives the ACK related to TB1. At time “n+8”, the UE transmits another transport block (TB2) to the eNB. At time “n+9”, the eNB receives TB2. At time “n+12”, the eNB transmits an ACK to the UE as confirmation that TB2 was successfully received. At time “n+13”, the UE receives the ACK related to TB2. In the ACK2 scheme, the UE drops TB1 from the transmit buffer (e.g., the RLC buffer) upon a consecutive reception of the ACK related to TB1 and the ACK related to TB2.

FIG. 6 shows a timing diagram 600 for an ACK/NDI scheme in accordance with an embodiment of the disclosure. More specifically, the timing diagram 600 shows a subframe index for communications between a UE and an eNB. At time “n”, a UE transmits a transport block (TB1) to an eNB. At time “n+1”, the eNB receives TB1. At time “n+4”, the eNB transmits an ACK to the UE as confirmation that TB1 was successfully received. The eNB also transmits an NDI to indicate that a new transport block is being sent. At time “n+5”, the UE receives the ACK related to TB1 and the NDI. In the ACK2 scheme, the UE drops TB1 from the transmit buffer (e.g., the RLC buffer) upon reception of the ACK related to TB1 and the NDI.

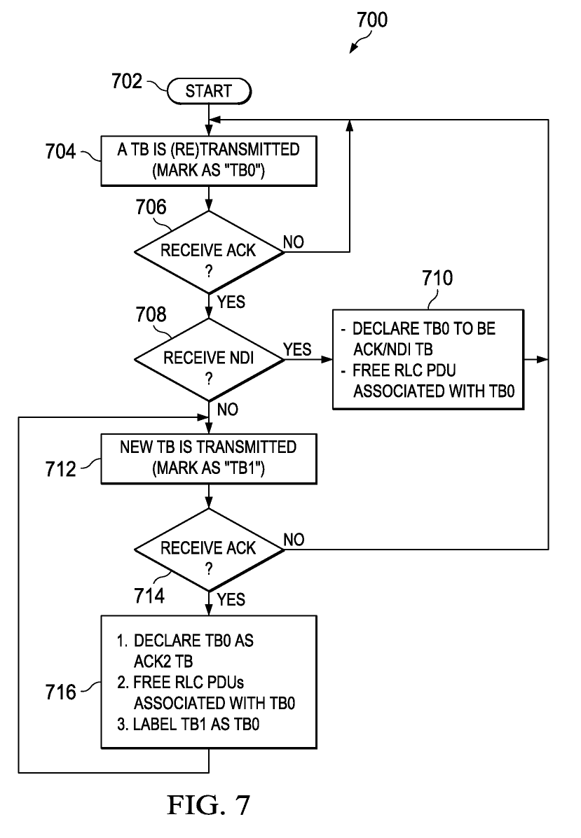

FIG. 7 shows a method 700 in accordance with an embodiment of the disclosure. The method 700 may be performed, for example, by a transmitting LTE device and enables reduction of the transmit buffer size. As shown, the method 700 starts at block 702. At block 704, a TB is transmitted or retransmitted. In some embodiments, the transmitted TB may be marked (e.g., as TB0) to distinguish it from other TBs. If an ACK is not received for TB0 (decision block 706), the method 700 returns to block 702. If an ACK is received for TB0 (decision block 706), the method 700 determines if an NDI is received (decision block 708). If an NDI is also received (decision block 708), TB0 is declared to be an ACK/NDI TB and the RLC PDU associated with TB0 is dropped (freed) from the transmit buffer of the transmitting device (block 710). The method 700 then returns to block 702. If an NDI is not received (decision block 708), a new TB is transmitted (block 712). In some embodiments, the newly transmitted TB may be marked (e.g., as TB1) to distinguish it from other TBs. If an ACK is not received for TB1 (decision block 714), the method 700 returns to block 702. If an ACK is received for TB1 (decision block 714), TB0 is declared to be an ACK2 TB and the RLC PDU associated with TB0 is dropped (freed) from the transmit buffer of the transmitting device (block 716). At block 716, TB1 also may be labeled as TB0. Subsequently, the method 700 returns to block 712.

Implementation of the method 700 causes storing a data block in a transmit buffer. Before receipt of a remotely-generated status report related to the data block, the data block is dropped based on a locally-generated status report related to the data block. In some embodiments, the locally-generated status report is generated (e.g., by a MAC Layer) upon receipt of two consecutive HARQ ACKs. Additionally, the locally-generated status report is generated (e.g., by a MAC Layer) upon receipt of a HARQ ACK and a new data indicator (NDI). In accordance with some embodiments, the locally-generated status report is forwarded from the MAC layer to a Radio Link Control (RLC) layer to enable the data block to be dropped from the transmit buffer. Thus, for some embodiments, the size of the transmit buffer is selected based on an estimation of locally-generated status report parameters (e.g., frequency, error probability).

Assume, for example, that a UE has infinitely queued data to send (i.e., the UE is allowed to transmit data at every subframe). If a TB is identified as an ACK2 TB and this TB was in fact not actually delivered, all the other RLC PDUs associated with the TB will be dropped. However, the frequency of misinterpreting a TB as an ACK2 TB is on the same order as the packet error rate (PER) in the RLC AM mode. More specifically, the ACK2 misinterpretation occurs only if a predetermined sequence of events is true. This sequence of events is: 1) the ACK2 TB was not successfully received at the eNB; 2) the first ACK was a NACK-to-ACK error; and 3) the second ACK was a NACK-to-ACK error. If events 1 and 2 are true, but event 3 is not true (i.e., the second ACK was indeed an ACK sent by the eNB), then the UE will transmit a new TB if the UE received the first ACK. Since the first TB was not received successfully and is not the last retransmission of the HARQ round, the eNB will combine the new TB and the lastly received TB. This combination will generate a NACK from the eNB with high probability since two consecutive TBs hold different data (e.g., different RLC PDU sequence numbers) and thus the likelihood of the combination passing CRC is negligible. Thus, the probability of an ACK2 misinterpretation (events 1, 2, 3 occurring) is (3e-1)*(1e-4)*(1e-4)=3e-9. In comparison to the target reliability of the RLC AM mode (1e-6 to 1e-9), the probability of ACK2 misinterpretation is sufficiently low.

In LTE, the uplink transmission is granted to the UE in several different ways, including non-persistent and semi-persistent allocations. Non-persistent allocation corresponds to the UE receiving an explicit bandwidth allocation for every uplink transmission. Semi-persistent allocation corresponds to the UE receiving a pre-allocated resource over an extended period of time without explicit signaling. In this case, the eNB may send explicit allocation instructions during the time of semi-persistent allocation, in which case the explicit allocation overrides the previously granted semi-persistent allocation. The allocation may be signaled from the eNB to the UE via the Physical Downlink Control Channel (PDCCH). The PDCCH also provided information for HARQ such as redundancy version and a new data indicator (NDI).

Assuming that PDCCH allocation is associated with data transmission related to the second ACK of the ACK2 scheme, the following scenarios are considered. For non-persistent allocation, the scenarios are: 1) allocation not present; 2) allocation present, but the UE fails to decode; and 3) allocation present and decoded. For scenario 1, the ACK2 scheme is not relevant. For scenario 2, the probability of decode failure is 1e-2 to 1e-3. Since the UE did not receive PDCCH allocation, the UE is unable to transmit a new TB. For scenario 3, an optimized ACK2 scheme is possible (the combination of ACK2 and the ACK/NDI schemes). In scenario 3, the UE knows whether the next transmission corresponds to a new transmission or a retransmission. If the allocation is for a new transmission (as indicated by the decoded NDI), the UE frees the buffered TB. The likelihood that the UE successfully decodes an allocation that was not intended for the UE is sufficiently small that the NDI information can be relied upon to free RLC PDUs by generating status reports locally.

The above scenarios may also be considered for semi-persistent PDCCH allocation. Again, the scenarios are: 1) allocation not present; 2) allocation present, but the UE fails to decode; and 3) allocation present and decoded. For scenario 1, the bandwidth allocation for the eNB is implicit and reliance on the accuracy of HARQ feedback is important. Thus, the ACK2 scheme is useful. For scenario 2, the ACK2 scheme is again applicable. In scenario 2, the PDCCH allocation may indicate the same resource with the HARQ information or a different resource. In either case, the ACK2 scheme is applicable. For scenario 3, the UE knows whether the next transmission corresponds to a new transmission or a retransmission. If the allocation is for a new transmission (as indicated by the decoded NDI), the UE frees the buffered TB. The likelihood that the UE successfully decodes an allocation that was not intended for the UE is sufficiently small that the NDI information can be relied upon to free RLC PDUs by generating status reports locally.

The round-trip time for the ACK2 scheme can be determined as 8 ms (for the second TB transmission)+4 ms (ACK arrival)+1 ms (propagation and decoding)=13 ms (see FIG. 5). 13 ms is approximately half the time that would be needed if the HARQ re-ordering timer and/or the polling period is used to determine when to drop data blocks from the transmit buffer. Thus, the intermediate storage for the newly arriving and outstanding uplink data can be reduced. In summary, the ACK2 and the ACK/NDI schemes can be used to reduce the transmit buffer requirements without compromising the reliability guaranteed by the RLC AM mode.

Further, the ACK2 and the ACK/NDI schemes have minimal impact on other layers besides the HARQ-ARQ interaction. In at least some embodiments, the ACK2 scheme is independent of the RLC modes that may be multiplexed into a single TB. As an example, a TB and its associated RLC PDUs may be de-allocated regardless of the RLC PDUs being in UM, TM or AM mode. If the UE detects an ACK2 misinterpretation, the UE can simply request a reset of the RLC states for the eNB and the UE. Such action would occur as rarely (probability 3e-9) as the failure of RLC layer ARQ in AM mode, in which case a similar action is taken (a reset of the RLC states)

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wireless communication device, comprising:
a transmit buffer; and
control logic coupled to the transmit buffer, wherein the control logic selectively implements an “ACK2 scheme” that drops a data block in the transmit buffer based on reception of two consecutive HARQ ACKs associated with the data block.

2. The wireless communication device of claim 1 wherein the transmit buffer is sized based on the ACK2 scheme.

3. The wireless communication device of claim 2 wherein the transmit buffer is sized based on the buffer reduction formula: [T_{NACK2}−(α*T_{ACK2}+β*T_{NACK2})]/T_{NACK2}, where T_{NACK2}=status report timing without the ACK2 scheme, T_{ACK2}=status report timing with the ACK2 scheme, α=a percentage estimate of how often the ACK2 scheme is used, and β=1−α.

4. The wireless communication device of claim 1 wherein the control logic selectively implements an “ACK/NDI scheme” that drops a data block in the transmit buffer based on reception of a HARQ ACK associated with the data block and reception of a new data indicator (NDI).

5. The wireless communication device of claim 4 wherein the transmit buffer is sized based on the ACK/NDI scheme.

6. The wireless communication device of claim 4 wherein the control logic implements both the ACK2 scheme and the ACK/NDI scheme.

7. The wireless communication device of claim 6 wherein the transmit buffer is sized based on the ACK2 scheme and the ACK/NDI scheme.

8. The wireless communication device of claim 1 wherein the transmit buffer is part of a Radio Link Control (RLC) layer.

9. The wireless communication device of claim 1 wherein the control logic is part of a Media Access Control (MAC) layer.

10. The wireless communication device of claim 1 wherein the control logic operates only during Acknowledged Mode (AM) operation of the wireless communication device.

11. A transmitter, comprising:
a Radio Link Control (RLC) layer with an RLC buffer, the RLC layer causes a data block in the RLC buffer to be dropped in response to a local RLC status report; and
a Media Access Control (MAC) layer coupled to the RLC layer, wherein the MAC layer generates the local RLC status report upon receipt of a HARQ ACK corresponding to the data block and a supplemental validity indicator for the data block.

12. The transmitter of claim 11 wherein the supplemental validity indicator is a subsequent HARQ ACK related to the data block.

13. The transmitter of claim 11 wherein the supplemental validity identifier is a new data indicator (NDI).

14. The transmitter of claim 11 wherein the RLC buffer is sized based on an estimation of how often local RLC status reports will be generated.

15. A method for a Long Term Evolution (LTE) device, comprising:
storing a data block in a transmit buffer;
dropping the data block from the transmit buffer before receipt of a remotely-generated status report related to the data block based on a locally-generated status report related to the data block.

16. The method of claim 15 further comprising generating the locally-generated status report upon receipt of two consecutive HARQ ACKs.

17. The method of claim 15 further comprising generating the locally-generated status report upon receipt of a HARQ ACK and a new data indicator (NDI).

18. The method of claim 15 further comprising further comprising generating the locally-generated status report by a Media Access Control (MAC) layer.

19. The method of claim 18 wherein further comprising forwarding the locally-generated status report from the MAC layer to a Radio Link Control (RLC) layer to enable said dropping.

20. The method of claim 15 wherein a size of the transmit buffer is selected based on an estimation of locally-generated status report parameters.
